(19) United States
(12) Patent Application Publication
(10) Pub. No.: US 2008/0066628 A1
(43) Pub. Date: Mar. 20, 2008

(54) Apparatus for making and storage of yogurt

(75) Inventors: Yushen Qian, Monroe Township, NJ (US); Li Wei Tan, Shanghai (CN); Yao Chen, Shanghai (CN); Ziye Qian, Monroe Township, NJ (US)

Correspondence Address: Ziye Qian;ACU-MED Technology LLC, 8 Regina Drive, Monroe Township, NJ, 08831, US

(73) Assignee: ACU-MED Technology LLC, Monroe Township, NJ (US)

(21) Appl. No.: 11/523,816

(22) Filed: Sep. 19, 2006

(51) Int. Cl. A23C 3/02

(52) U.S. Cl. 99/453

(57) ABSTRACT

A machine can be used as both a yogurt maker and refrigerator in the household, consists of: a thermally insulated fermentation compartment, thermal couple, heating element, evaporator, expansion valve, refrigerant compressor, condenser, fan, selective switch, safety door switch, ultraviolet lamp, controller, and at least one milk container. Such units, controlled through pre-programmed cycles, can perform a variety of tasks: they are able to automatically disinfect the fermentation compartment and exterior of milk containers with conditions of 60° C.˜80° C., dry air, and ultraviolet light; prepare yogurt by distributing transformation culture into milk; maintain cold temperature for extended periods of time; subsequent self-disinfection to decrease contamination.

### CROSS REFERENCE

CROSS REFERENCE
U.S. PATENT DOCUMENTS

| | | | |
|---|---|---|---|
| 3,685,153 | August 1972 | Borkton. | |
| 3,975,239 | August 1976 | Stamer | 435/800 X |
| 4,009,368 | February 1977 | Faivre et al.. | |
| 4,163,472 | August 1979 | Taylor | 99/453 |
| 4,195,561 | April 1980 | Castanis. | |
| 5,013,158 | May 1991 | Tarlow | 99/348 X |
| 5,829,344 | November 1998 | Landé | 99/453 |
| 5,979,300 | November 1999 | Donovan | 99/323 |
| 6,571,690 | June 2003 | Hsu | 99/453 |

FOREIGN PATENT DOCUMENTS

| | | |
|---|---|---|
| 57091151 | February 1976 | Japan |

### BACKGROUND OF THE INVENTION

The current methodology of homemade yogurt preparation involves tedious boiling of fresh milk, cool down to specified temperatures that accommodate survival of active cultures, addition and subsequent mixing of the culture in milk, compartmentalization of the milk into sterilized containers, and incubation of these containers at 38° C.-46° C. for 8 hours. Following the successful transformation of milk into yogurt, it is necessary to first cool them at room temperature and store within a refrigerator.

However, several flaws are associated with the above process:
The milk must often be manually heated to boiling and cooled down—both time inefficient processes.
Following incubation, one must allow yogurt to equilibrate at room temperature, and then store within a refrigerator.
Cleaning, disinfection, and drying of fermentation chamber must be done manually.
When the yogurt maker is not in use, it presents no alternative functionality.
Manual loading and unloading of incubator and refrigerator increases the chance of contamination.
Yogurt will denature if time and temperature settings are not set at optimal conditions.

There are two types of yogurt makers: one requires manual heating of the milk and addition of culture; the second type uses electricity to heat cultured milk to set temperatures. However, both these types of yogurt makers require manual handling of containers and/or pots. Furthermore, contamination is likely since the incubation environment of the fermentation chamber presents optimal conditions for growth of undesired bacteria.

The proposed invention utilizes a novel mechanism in order to circumvent these problems. The machine is capable of running automated cycles that have been optimized and programmed. Thus, the benefits include reduced contamination, automated self-disinfection, self-efficiency, as well as a secondary functionality as another refrigerator.

### SUMMARY OF THE INVENTION

The purpose of this invention is to provide an affordable household yogurt maker with self-disinfection functions in order to maintain the integrity of yogurt by reducing human contamination. Whenever this novel machine has completed making yogurt, it will automatically switch to its secondary function as a refrigerator.

Regarding the initial disinfection process, the machine achieves a rapid increase in temperature without overheating the active culture by using: electrical heaters, lamps, or other semiconductor heaters; a thermally insulated compartment; an ultraviolet lamp (UVL); a fan to maintain air flow and temperature homogeneity in the fermentation compartment. Furthermore, the milk containers can block UV to kill the active culture added to the milk. During incubation, the machine will keep temperature constant at 43° C. through PID (Proportional Integral Derivative) controlling so that air temperature will not be affected by outside environment and production load.

Regarding the machine's secondary functionality as a refrigerator, cooling is achieved through a refrigerant compressor, condenser, expansion valve, and evaporator. This will export heat from the fermentation compartment and maintain cool temperature.

Furthermore, the machine can also be used as a kitchen disinfection appliance.

### DESCRIPTION OF THE DRAWINGS

FIG. 1 is a schematic view of the proposed invention.

FIG. 2 is a time-wise comparison of the temperature changes in the air and milk of the incubation compartment.

### DETAILED DESCRIPTION

The proposed invention is capable of performing under three functional modes: Yogurt maker, refrigerator, and disinfection appliance. People can use mode switch 13 to select the desired function.

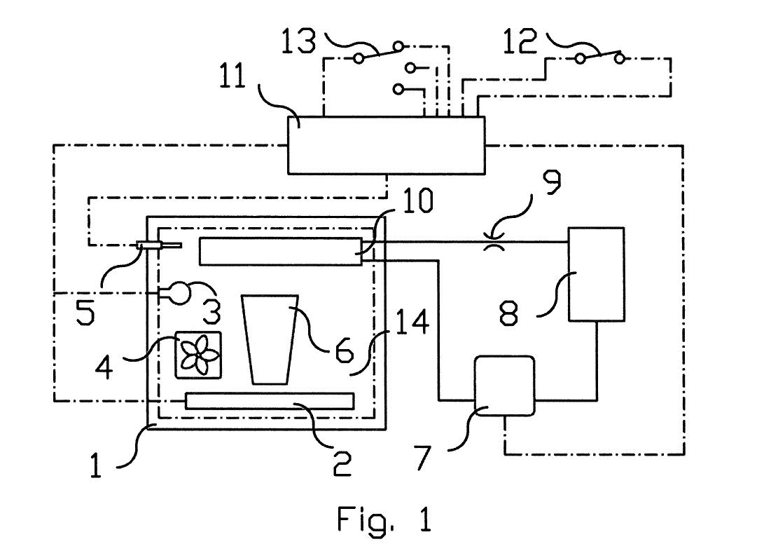

Referring to FIG. 1, the machine operates through two primary mechanisms.

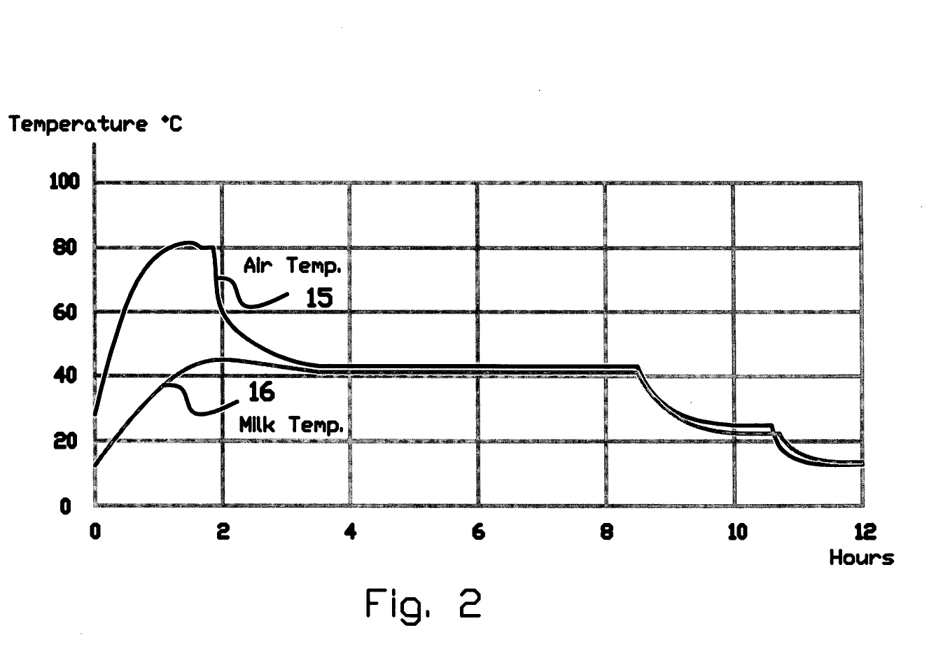

The mechanism of heating is applied to disinfection and incubation processes. It is achieved by using: a heating element 2 which serves as an electrical heater; one or a group of lamps or the semiconductor heating component is installed onto the bottom of a thermally insulated housing 1, which builds a fermentation compartment 14, which in turn is used to warm the air in compartment 14, thus indirectly heating the cultured milk within the container(s) 6. At the beginning of yogurt preparation, there is a process of disinfection that pumps hot dry air (60° C. to 82° C.) for at least 5 minutes to kill undesired bacteria in thermally insulated compartment 14 and outside of milk container(s) 6 which can block UV to kill the active culture added to the milk. Simultaneously, ultraviolet lamp 3 is turned on to use UV rays to disinfect fermentation compartment 14. Due to the thermal inertia of milk in the container(s) 6, its temperature remains at about 45° C. before the end of disinfection, and thus preserves the active culture. During fermentation, temperature in the compartment 14 is kept at 43° C. with PID (Proportional Integral Derivative) technology. There is a safety door switch 12, which will let controller 11 cut off power to the UV lamp 3, fan 4 and heating element 2 so to prevent human injury during disinfection and incubation. The fan 4 runs during the disinfection and incubation processes to promote temperature homogeneity. The thermal couple 5, on the top of fermentation compartment 14, informs controller 11 the temperature readout in the compartment 14. The controller 11 then dictates temperature of disinfection and incubation processes in the compartment 14. In accordance with FIG. 2, the disinfection process takes about 1-1.5 hours depending on the production load. The incubation process requires seven hours, and three hours are needed for natural cooling. Afterwards, the controller 11 switches the machine to serve its secondary refrigerator function.

The second mechanism of cooling, which is used to serve as a refrigerator, is achieved using: an evaporator 10 under the ceiling of fermentation compartment 14, refrigerant compressor 7 which compresses refrigerant to high pressures and hot temperatures, which in turn is released from evaporator 10. This refrigerant steam passes through condenser 8 and condenses into liquid, which passes through expansion valve 9, which changes it to low pressure liquid and sends it to evaporate through the evaporator 10 again. Because liquid refrigerant intrinsically possesses a large specific heat, the above method is very efficient in exporting heat from fermentation compartment 14. This cooling mechanism is controlled by controller 11 integrated with thermal couple 5—the air temperature in the fermentation compartment 14 is always kept between 5° C. and 16° C. Therefore, users may treat the machine as an extra refrigerator.

The temperature changes in compartment 14 and curve 15 as well as in milk temperature within container(s) 6 and curve 16 during disinfection and incubation within the fermentation compartment 14 are presented in FIG. 2.

This invention also possesses a tertiary function as a kitchen disinfection appliance. Users can use it to disinfect milk container(s) 6 and kitchen utensils such as knives, trays, spoons, and forks. This mode is activated through switch 13. The machine will use ultraviolet light as well as hot dry air at 82° C. in the fermentation compartment 14 to sterilize the targets and fermentation compartment 14. This process requires at least forty minutes.

We present the following claims:

1. An automated household yogurt maker is composed of the following:
The heating means includes housing in fermentation compartment, heating elements, thermal couple, fan, and UV disinfection lamp, all of which are installed into the fermentation compartment. A controller with pre-programmed software controls the temperature in the fermentation compartment during disinfection and incubation.
The cooling means includes an evaporator, an expansion valve and a thermal couple installed in the fermentation compartment. There is also a refrigerant compressor and condenser. The controller controls the temperature in the fermentation compartment during refrigeration.

2. An automated household yogurt maker as claimed 1 uses hot dry air as well as ultraviolet light to disinfect the interior of the fermentation compartment and exterior of milk container(s).

3. An automated household yogurt maker as claimed 1 can switch between three different functionalities: yogurt maker, small refrigerator, and kitchen disinfection appliance.

4. An automated household yogurt maker as claimed 1 automatically reverts to refrigeration mode after completing the disinfection and incubation process.
